(19) United States
(12) Patent Application Publication
(10) Pub. No.: US 2026/0127803 A1
(43) Pub. Date: May 7, 2026

(54) VIRTUAL PERFORMER EXPRESSION ADJUSTMENT SYSTEM WITH EMOTION-AWARE AND METHOD THEREOF

(71) Applicants: SQ Technology (Shanghai) Corporation, Shanghai (CN); Inventec Corporation, Taipei (TW)

(72) Inventors: Chuan-Cheng CHIU, Taipei (TW); Hai-Hong SHA, Shanghai (CN); Po-Shuo CHIU, Taipei (TW)

(73) Assignees: SQ Technology (Shanghai) Corporation, Shanghai (CN); Inventec Corporation, Taipei (TW)

(21) Appl. No.: 19/021,153

(22) Filed: Jan. 14, 2025

(30) Foreign Application Priority Data
Nov. 7, 2024 (CN) 202411587148X

(51) Int. Cl. G06T 13/40; G06T 11/00; G06T 13/20; G06T 13/80; G10L 15/02; G10L 15/06; G10L 15/16; G10L 25/63

(52) U.S. Cl. CPC G06T 13/40; G06T 11/00; G06T 13/205; G06T 13/80; G10L 15/02; G10L 15/063; G10L 15/16; G10L 25/63

(57) ABSTRACT

A virtual performer expression adjustment system with emotion-aware and a method thereof are disclosed. In the system, voice signals and corresponding emotion messages are loaded initially as training data, the loaded data is input into an artificial intelligence model to perform training to generate an emotion recognition model; a user voice is received to perform feature extraction, standardization and dimensionality reduction processes, the processed user voice is input into an emotion recognition model to obtain an emotional status, an facial expression generation calculation is then executed to generate facial landmarks based on the emotional status, and face model parameters of a virtual performer are adjusted based on the facial landmarks in real time, for dynamically displaying a facial expression of the virtual performer. Therefore, the technical effect of enhancing the realism and richness of the virtual performer's expressions can be achieved.

### BACKGROUND OF THE INVENTION

### 1. Field of the Invention

The present invention relates to an expression adjustment system and a method thereof, and more particularly to a virtual performer expression adjustment system with emotion-aware and a method thereof.

### 2. Description of the Related Art

In recent years, with the rapid development and widespread adoption of virtual technologies, various applications of virtual technologies have emerged rapidly. Among the applications, the economic value of virtual performers has attracted the most attention.

Generally, an existing virtual performer typically obtains motions and even expressions through a motion capture technology. This conventional method allows the virtual performer to mimic human motions and expressions in real-time, but the equipment required for motion capture technology is overly complex and needs high synchronization, and even often require post-process, so the usability of the conventional method is greatly limited.

In view of this, some companies have proposed expression simulation technologies of directly pre-simulating various human expressions and applying them to virtual performers. However, this method can only vary expressions based on predefined workflows and may led to insufficient flexibility and usability of expressions, for example, the simulated expressions may lack richness and have rigidity; furthermore, this method may fail to synchronize with voice and cause dissonance and reducing realism, for example, angry tones may be paired with happy expressions. Therefore, this conventional method still fails to effectively resolve the lack of realism and richness in expressions of virtual performers.

According to above-mentioned contents, what is needed is to develop an improved solution to solve the problem of insufficient realism and richness in expressions of virtual performers.

### SUMMARY OF THE INVENTION

An objective of the present invention is to disclose a virtual performer expression adjustment system with emotion-aware and a method thereof, to solve the problem of insufficient realism and richness in expressions of virtual performers.

To achieve the objective, the present invention discloses a virtual performer expression adjustment system with emotion-aware, and the virtual performer expression adjustment system includes an emotional voice database and a computer host. The emotional voice database is configured to store voice signals and emotion messages, wherein each of the voice signals corresponds to one of the emotion messages. The computer host is connected to the emotional voice database and includes a non-transitory computer-readable storage medium and a hardware processor. The non-transitory computer-readable storage medium is configured to store computer readable instructions. The hardware processor is electrically connected to the non-transitory computer-readable storage medium, and configured to execute the computer readable instructions to operate: loading the voice signals and the emotion message corresponding to the loaded voice signals as training data from the emotional voice database, and inputting the training data into an artificial intelligence model to perform training to generate an emotion recognition model; receiving a user voice, performing feature extraction, standardization and dimensionality reduction processes on the user voice, and inputting the processed user voice into the emotion recognition model, to obtain an emotional status; executing a facial expression generation calculation to generate facial landmarks based on the emotional status, and adjusting face model parameters of a virtual performer based on the facial landmarks in real time, to dynamically display a facial expression of the virtual performer.

To achieve the objective, the present invention discloses a virtual performer expression adjustment method with emotion-aware, include steps of: connecting an emotional voice database to a computer host, wherein the emotional voice database stores voice signals and emotion messages, and each of the emotion messages corresponding to one of the voice signals; loading the voice signals and emotion message corresponding to the loaded voice signals as training data from the emotional voice database, and inputting the training data into an artificial intelligence model for training to generate an emotion recognition model, by the computer host; receiving a user voice, performing feature extraction, standardization and dimensionality reduction processes on the user voice, and inputting the processed user voice into the emotion recognition model to obtain an emotional status, by the computer host; executing a facial expression generation calculation to generate facial landmarks based on the emotional status, and adjusting face model parameters of a virtual performer based on the facial landmarks in real time, for dynamically displaying a facial expression of the virtual performer, by the computer host.

According to the system and method of the present invention, the difference between the present invention and the conventional technology is that, in the present invention, initially the voice signals and corresponding emotion messages are loaded as the training data, the loaded data is input into the artificial intelligence model to perform training to generate an emotion recognition model; the user voice is received to perform the feature extraction, standardization and dimensionality reduction processes, the processed user voice is input into the emotion recognition model to obtain the emotional status, the facial expression generation calculation is then executed to generate the facial landmarks based on the emotional status, and the face model parameters of the virtual performer are adjusted based on the facial landmarks in real time, for dynamically displaying the facial expression of the virtual performer.

Therefore, the above-mentioned solution of the present invention can achieve the technical effect of enhancing the realism and richness of the virtual performer's expressions.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a virtual performer expression adjustment system with emotion-aware, according to the present invention.

FIG. 2A and FIG. 2B are flowcharts of a virtual performer expression adjustment method with emotion-aware, according to the present invention.

FIG. 3 is a schematic view of facial landmarks of the present invention.

FIG. 4 is a schematic view of an operation of adjusting virtual performer's expression, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on”, “connected to” or “coupled to” another element or layer, it can be directly on, connected or coupled to the other element or layer, or intervening elements or layers may be present. In contrast, when an element is referred to as being “directly on”, “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

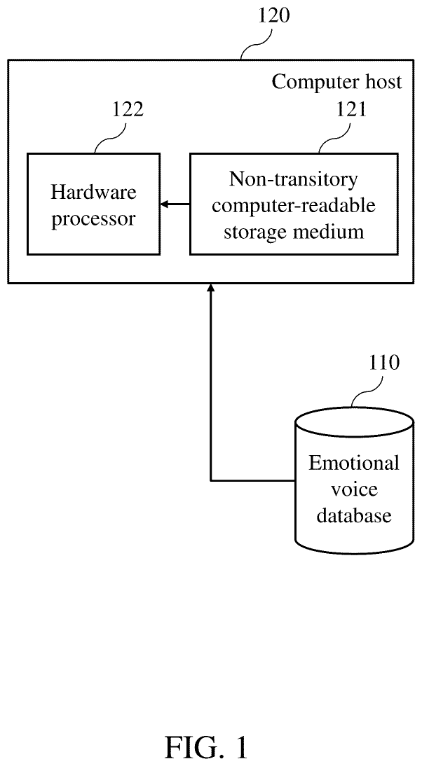

Please refer to FIG. 1. FIG. 1 is a block diagram of a virtual performer expression adjustment system with emotion-aware, according to the present invention. The virtual performer expression adjustment system includes an emotional voice database 110 and a computer host 120. The emotional voice database 110 is configured to store voice signals and emotion messages, each of the voice signals corresponds to one of the emotion messages. For example, an angry voice corresponds to an emotion message, which can be in multimodal formats, such as a text mentioning anger, an image or a video depicting anger.

The computer host 120 is connected to the emotional voice database 110 and includes a non-transitory computer-readable storage medium 121 and a hardware processor 122. The non-transitory computer-readable storage medium 121 is configured to store computer readable instruction. In actual implementation, the non-transitory computer-readable storage medium 121 may include a hard disk, an optical disk, a flash memory, or the like. The computer readable instructions can be executed by the hardware processor 122. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages.

The hardware processor 122 is electrically connected to the non-transitory computer-readable storage medium 121 and configured to execute the computer readable instructions to perform the following operations. The hardware processor 122 loads the voice signals and the emotion message corresponding to the loaded voice signals as training data from the emotional voice database and inputs the training data into an artificial intelligence model, to perform training to generate an emotion recognition model. The hardware processor 122 receives a user voice, performs feature extraction, standardization and dimensionality reduction processes on the user voice, and inputs the processed user voice into the emotion recognition model, to obtain an emotional status. The hardware processor 122 executes a facial expression generation calculation to generate facial landmarks based on the emotional status and adjusts face model parameters of a virtual performer based on the facial landmarks in real time, to dynamically display a facial expression of the virtual performer. In practical implementation, the emotion recognition model can include a convolutional neural network (CNN), and a recurrent neural network (RNN). In an embodiment, during a training process, the emotion recognition model is allowed to receive the emotion message containing text, images, videos, audio, or a combination thereof as the training data in multimodal forms. Additionally, the facial expression generation calculation can include at least one of a generative adversarial network (GAN), deep learning (DL), or reinforcement learning (RL), to generate a face image corresponding to the emotional status and extract the facial landmarks from the face image. Furthermore, the virtual performer can have a predefined facial expression model including the face model parameters, and after the facial landmarks are generated, the hardware processor 122 smooths the changes in the facial landmarks through a filter, executes a boundary check to remove an unnatural expression, maps the processed facial landmarks to the face model parameters to modify the facial expression model, so as to dynamically display the facial expression of the virtual performer. Furthermore, the hardware processor 122 can detect whether the facial landmarks match an inappropriate expression feature, when the facial landmarks match the inappropriate expression feature, the hardware processor 122 prohibits using the facial landmarks to adjust the face model parameters of the virtual performer and also initializes the face model parameters, thereby effectively preventing the virtual performer from exhibiting frightening or unnatural expression.

It is to be particularly noted that, in actual implementation, the above-mentioned solution of the present invention can be implemented fully or partly based on hardware, for example, the hardware processor 122 of the system can be implemented by integrated circuit chip, system on chip (SoC), a complex programmable logic device (CPLD), or a field programmable gate array (FPGA). The non-transitory computer-readable storage medium 121 of the present invention records computer readable program instructions, and the hardware processor 122 can execute the computer readable program instructions to implement concepts of the present invention. The non-transitory computer-readable storage medium 121 can be a tangible apparatus for holding and storing the instructions executable of an instruction executing apparatus. The non-transitory computer-readable storage medium 121 can be, but not limited to electronic storage apparatus, magnetic storage apparatus, optical storage apparatus, electromagnetic storage apparatus, semiconductor storage apparatus, or any appropriate combination thereof. More particularly, the non-transitory computer-readable storage medium 121 can include a hard disk, an RAM memory, a read-only-memory, a flash memory, an optical disk, a floppy disc, or any appropriate combination thereof, but this exemplary list is not an exhaustive list. The non-transitory computer-readable storage medium 121 is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer-readable storage medium 121 to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network and forward the computer readable program instruction to store in non-transitory computer-readable storage medium 121 of each calculating/processing apparatus.

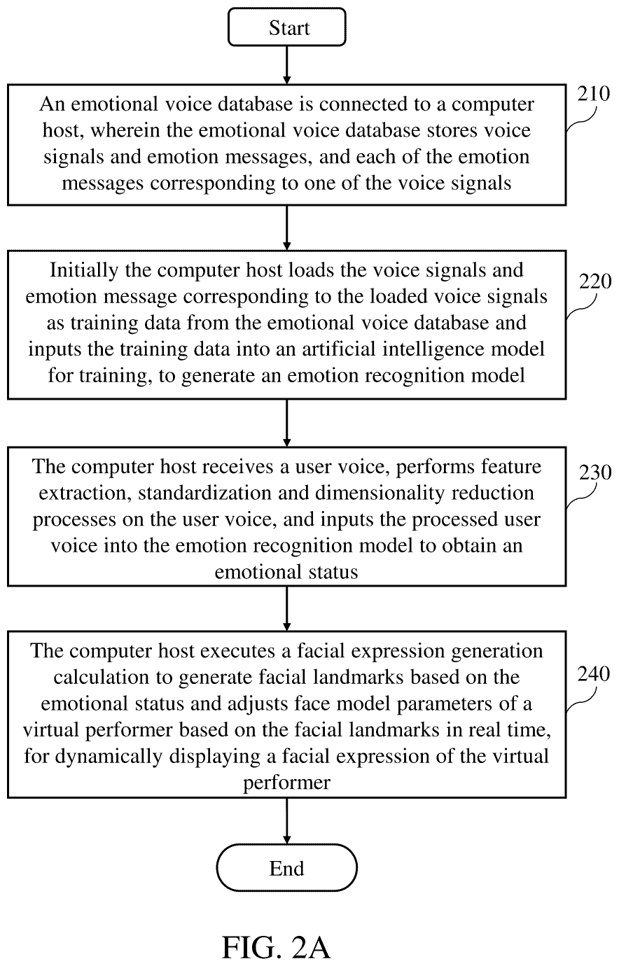

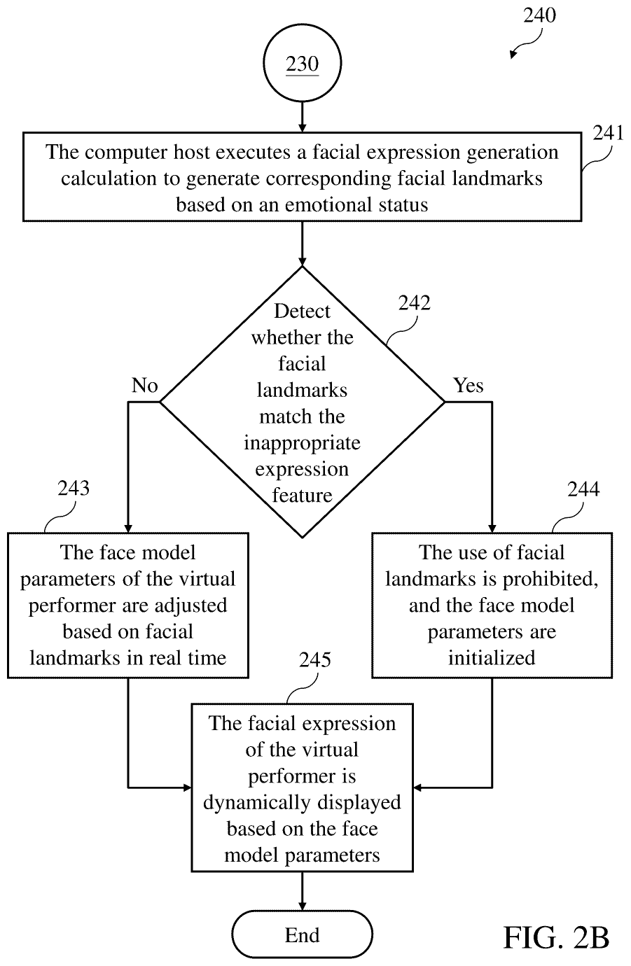

Please refer to FIG. 2A and FIG. 2B. FIG. 2A and FIG. 2B are flowcharts of a virtual performer expression adjustment method with emotion-aware, according to the present invention. As shown in FIG. 2A and FIG. 2B, the virtual performer expression adjustment method includes following steps. In a step 210, an emotional voice database 110 is connected to a computer host 120, wherein the emotional voice database 110 stores voice signals and emotion messages, and each of the emotion messages corresponding to one of the voice signals. In a step 220, initially the computer host 120 loads the voice signals and emotion message corresponding to the loaded voice signals as training data from the emotional voice database 110 and inputs the training data into an artificial intelligence model for training, to generate an emotion recognition model. In a step 230, the computer host 120 receives a user voice, performs feature extraction, standardization and dimensionality reduction processes on the user voice, and inputs the processed user voice into the emotion recognition model to obtain an emotional status. In a step 240, the computer host 120 executes a facial expression generation calculation to generate facial landmarks based on the emotional status and adjusts face model parameters of a virtual performer based on the facial landmarks in real time, for dynamically displaying a facial expression of the virtual performer. Through aforementioned steps, the voice signals and corresponding emotion messages are loaded initially as the training data, the loaded data is input into the artificial intelligence model to perform training to generate the emotion recognition model; the user voice is received to perform the feature extraction, standardization and dimensionality reduction processes, the processed user voice is input into the emotion recognition model to obtain the emotional status, the facial expression generation calculation is then executed to generate the facial landmarks based on the emotional status, and the face model parameters of the virtual performer are adjusted based on the facial landmarks in real time, for dynamically displaying the facial expression of the virtual performer.

It is to be particularly noted that the step 240 executed by the computer host 120 can further include following steps, as shown in FIG. 2B. In a step 241, a facial expression generation calculation is executed to generate corresponding facial landmarks based on an emotional status. In a step 242, it is detected whether the facial landmarks match the inappropriate expression feature. In a step 243, when the facial landmarks do not match the inappropriate expression feature, the face model parameters of the virtual performer are adjusted based on facial landmarks in real time. In a step 244, when the facial landmarks match the inappropriate expression feature, the use of facial landmarks is prohibited, and the face model parameters are initialized. In a step 245. the facial expression of the virtual performer is dynamically displayed based on the face model parameters. Besides the step 240 shown in FIG. 2A, the steps 242 and 244 are added in FIG. 2B to solve the situation where the facial landmarks match inappropriate expression feature, thereby enabling appropriate processes. The steps can effectively prevent virtual characters from exhibiting inappropriate expressions, such as unnatural or frightening expressions.

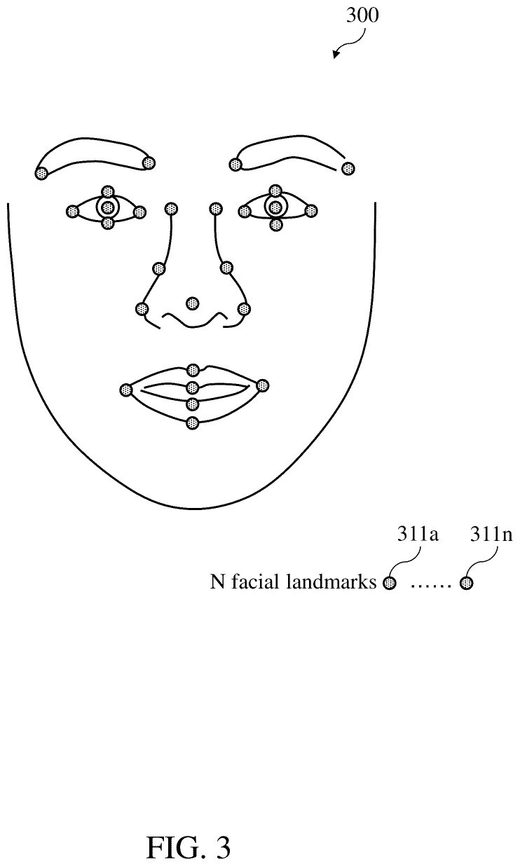

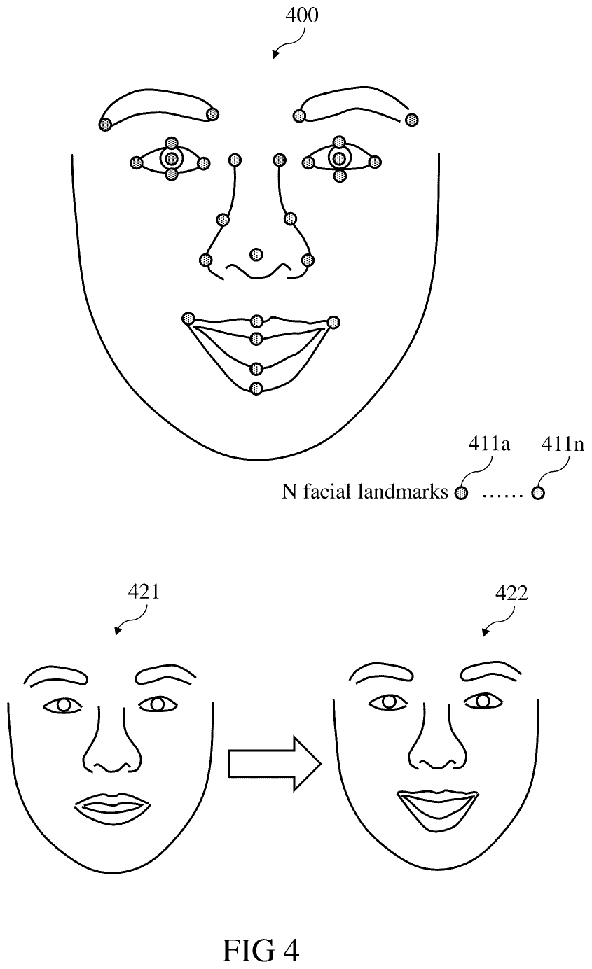

An embodiment of the present invention will be illustrated in the following paragraphs with reference to FIG. 3 and FIG. 4. Please refer to FIG. 3. FIG. 3 is a schematic view of facial landmarks, according to the present invention. The facial landmarks 311a˜311n in the present invention refers to specific and significant regions on a human face 300, such as the corners of the eyes, eyebrows, nose tip, and lips'edges, and are used in describing a structure and expression of a face. The facial landmarks 311a˜311n can be in number N being a positive integer, and used in identifying and analyzing the shape, motion, and emotion of a human face. Hence, the facial landmarks are widely applied in computer vision and image processing. In practical implementation, they can be identified using a standard facial landmarks detection model (e.g., Dlib or OpenFace) to generate the facial landmarks 311a˜311n from an image or picture. Practically, detecting the facial landmarks 311a˜311n can be implemented by using machine learning (e.g., support vector machines or regression models), deep learning (e.g., convolutional neural networks, hourglass networks), or similar methods like PIPNet (Pixel-in-Pixel Net). During a training process, the model can learn to automatically identify positions of feature points on images and generate the corresponding facial landmarks 311a˜311n and coordinates thereof. It is to be particularly noted that the emotional status output by the emotion recognition model in the present invention is multimodal data (ex, the data in multimodal format) such as texts, images, or videos. When the emotion recognition model outputs images or videos, the facial landmarks can be generated through the above-mentioned method. When the emotion recognition model outputs a text, the facial landmarks representing various emotions can be pre-mapped to texts, e.g., a text being “anger” is mapped to facial landmarks representing an angry face, or a text being “happy” is mapped to facial landmarks representing a happy face, and so on, so that corresponding facial landmarks can be generated based on the text output from the emotion recognition model. It should be explained that the facial landmarks are represented using circular dots for illustration convenience.

Please refer to FIG. 4. FIG. 4 is a schematic view of adjusting virtual performer's expression, according to an application of the present invention. In practical implementation, at an initial stage, a computer host 120 loads voice signals and emotion messages corresponding thereto as training data from an emotional voice database 110 and inputs the training data into an artificial intelligence model, to perform training to generate an emotion recognition model. The emotion recognition model allows input of a user voice to identify or predict an emotional status of the user voice. In an embodiment, the emotional status can be a text, an image or video, such as a text being “happy”, an image being a happy face image, or a video being a happy face video.

When the computer host 120 receives the user voice, the computer host 120 performs feature extraction, standardization and dimensionality reduction processes on the received user voice and inputs the processed user voice into the emotion recognition model to obtain an emotional status, such as a happy face image 400, as shown in FIG. 4. Subsequently, the computer host 120 executes a facial expression generation calculation to generate corresponding facial landmarks 411a˜411n based on the emotional status (e.g., the happy face image 400), and the facial landmarks is in the number N (N being a positive integer). The face model parameters of a virtual performer are adjusted based on the facial landmarks 411a˜411n in real time, for example, in a condition that the virtual performer has an initial expression 421, after being adjusted based on the facial landmarks 411a˜411n, the expression of the virtual performer is changed from the initial expression 421 to a happy expression 422, as shown in FIG. 4, thus, the expression adjustment of the virtual performer is completed. It should be explained that, to avoid unnatural expressions, the changes in the facial landmarks 411a˜411n can be smoothed through a filter, a boundary check can be executed to remove an unnatural expression, and the processed facial landmarks 411a˜411n are then mapped to the face model parameters to change the facial expression model of the virtual performer.

According to above-mentioned contents, the difference between the present invention and the conventional technology is that, in the present invention, initially the voice signals and corresponding emotion messages are loaded as the training data, the loaded data is input into the artificial intelligence model to perform training to generate an emotion recognition model; the user voice is received to perform the feature extraction, standardization and dimensionality reduction processes, the processed user voice is input into the emotion recognition model to obtain the emotional status, the facial expression generation calculation is then executed to generate the facial landmarks based on the emotional status, and the face model parameters of the virtual performer are adjusted based on the facial landmarks in real time, for dynamically displaying the facial expression of the virtual performer. Therefore, the above-mentioned solution of the present invention can solve the conventional problem and achieve the technical effect of enhancing the realism and richness of the virtual performer's expressions.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A virtual performer expression adjustment system with emotion-aware, comprising:
an emotional voice database, configured to store voice signals and emotion messages, wherein each of the voice signals corresponds to one of the emotion messages; and
a computer host, connected to the emotional voice database and comprising:
a non-transitory computer-readable storage medium, configured to store computer readable instructions; and
a hardware processor, electrically connected to the non-transitory computer-readable storage medium, and configured to execute the computer readable instructions to operate:
loading the voice signals and the emotion message corresponding to the loaded voice signals as training data from the emotional voice database, and inputting the training data into an artificial intelligence model to perform training to generate an emotion recognition model;
receiving a user voice, performing feature extraction, standardization and dimensionality reduction processes on the user voice, and inputting the processed user voice into the emotion recognition model to obtain an emotional status; and
executing a facial expression generation calculation to generate facial landmarks based on the emotional status, and adjusting face model parameters of a virtual performer based on the facial landmarks in real time to dynamically display a facial expression of the virtual performer.

2. The virtual performer expression adjustment system with emotion-aware according to claim 1, wherein the emotion recognition model comprises a convolutional neural network (CNN), and a recurrent neural network (RNN), and during a training process, the emotion recognition model is allowed to receive the emotion message containing text, images, videos, audio, or a combination thereof as the training data in multimodal forms.

3. The virtual performer expression adjustment system with emotion-aware according to claim 1, wherein the facial expression generation calculation is performed by at least one of a generative adversarial network (GAN), deep learning (DL) and reinforcement learning (RL), and is configured to generate an face image corresponding to the emotional status and extract the facial landmarks from the face image.

4. The virtual performer expression adjustment system with emotion-aware according to claim 1, wherein the virtual performer has a predefined facial expression model, the facial expression model comprises the face model parameters, after the facial landmarks are generated, a change of the facial landmarks is smoothed through a filter, a boundary check is executed to remove an unnatural expression, and the processed facial landmarks are mapped to the face model parameters to modify the facial expression model.

5. The virtual performer expression adjustment system with emotion-aware according to claim 1, wherein the hardware processor further operates:
detecting whether the facial landmarks match an inappropriate expression feature; and
when the facial landmarks match the inappropriate expression feature, prohibit using the facial landmarks to adjust the face model parameters of the virtual performer, and initializing the face model parameters.

6. A virtual performer expression adjustment method with emotion-aware, comprising:
connecting an emotional voice database to a computer host, wherein the emotional voice database stores voice signals and emotion messages, and each of the emotion messages corresponding to one of the voice signals;
loading the voice signals and emotion message corresponding to the loaded voice signals as training data from the emotional voice database, and inputting the training data into an artificial intelligence model for training to generate an emotion recognition model, by the computer host;
receiving a user voice, performing feature extraction, standardization and dimensionality reduction processes on the user voice, and inputting the processed user voice into the emotion recognition model to obtain an emotional status, by the computer host; and
executing a facial expression generation calculation to generate facial landmarks based on the emotional status, and adjusting face model parameters of a virtual performer based on the facial landmarks in real time for dynamically displaying a facial expression of the virtual performer, by the computer host.

7. The virtual performer expression adjustment method with emotion-aware according to claim 6, wherein the emotion recognition model comprises a convolutional neural network (CNN), and a recurrent neural network (RNN), and during a training process, the emotion recognition model is allowed to receive the emotion message containing text, images, videos, audio, or a combination thereof as the training data in multimodal forms.

8. The virtual performer expression adjustment method with emotion-aware according to claim 6, wherein the facial expression generation calculation is performed by at least one of a generative adversarial network (GAN), deep learning (DL) and reinforcement learning (RL), and is configured to generate an face image corresponding to the emotional status, extract the facial landmarks from the face image.

9. The virtual performer expression adjustment method with emotion-aware according to claim 6, wherein the virtual performer has a predefined facial expression model, the facial expression model comprises the face model parameters, after the facial landmarks are generated, a change of the facial landmarks is smoothed through a filter, a boundary check is executed to remove an unnatural expression, and the processed facial landmarks are mapped to the face model parameters to modify the facial expression model.

10. The virtual performer expression adjustment method with emotion-aware according to claim 6, further comprising:
detecting whether the facial landmarks match an inappropriate expression feature, by the hardware processor; and
when the facial landmarks match the inappropriate expression feature, prohibiting using the facial landmarks to adjust the face model parameters of the virtual performer and initializing the face model parameters, by the hardware processor.
